(19) United States
(12) Patent Application Publication
(10) Pub. No.: US 2007/0069149 A1
(43) Pub. Date: Mar. 29, 2007

(54) Combined aperture holder, beam blanker and vacuum feed through for electron beam, ion beam charged particle devices

(76) Inventor: Earl Weltmer, Tustin, CA (US)

Correspondence Address: KENNETH J. HOVET;NORDMAN, CORMANY, HAIR & COMPTON LLP, P.O. BOX 9100, 1000 TOWN CENTER DRIVE, OXNARD, CA, 93031-9100, US

(21) Appl. No.: 11/238,570

(22) Filed: Sep. 29, 2005

(51) Int. Cl. H01J 3/38

(52) U.S. Cl. 250/396 R

(57) ABSTRACT

A combined aperture, aperture holder, vacuum feed through and beam blanker for a beam of charged particles fits into an existing aperture in a charged particle beam device such as a scanning electron microscope or an ion beam chamber.

This invention relates to charged particle beam blanker and electron beam blanker for devices such as scanning electron microscopes (SEMs) and Focused Ion Beams (FIB). More particularly, this invention relates to a combined/integrated aperture holder, beam blanker and vacuum feed through device that fits into an existing port in such devices.

Scanning electron microscopes (SEM) or Focused Ion Beams (FIB) may be used to make small semi-conductor and mechanical devices by techniques such as nanofabrication. In scanning electron microscopes, the scan coils are connected to a computer, and an electron beam is moved in a desired pattern over a beam-sensitive target or sample. When so used, the beam forms an exposed area of desired size and shape in the sample.

In use, scanning electron microscopes (SEMs) and Focused Ion Beams (FIB) generate and direct a stream or beam of electrons or ions toward a sample. A beam blanker electronically diverts such a beam from the axis of such a device. The blanker includes two opposing electrodes alongside the axis or path of the beam, as shown, for example, in FIGS. 1 and 1A.

Many of these devices (SEM or FIB) may not have access openings or ports adequate for installing beam blanker plates and a vacuum feed through. Forming new openings or new ports in such devices is expensive, time-consuming, and difficult, and may void a manufacturer's warranty. Using existing vacuum or other ports, and combining the vacuum feed through with a beam blanker and an aperture holder, avoids these problems.

### BRIEF DESCRIPTION OF THE DRAWINGS

The combined beam blanker for electron beam and ion beam devices, aperture holder and vacuum feed through, can better be understood by reference to the drawings in which:

FIG. 1 and FIG. 1A show a cross sectional view of a scanning electron microscope column that includes beam blanker plates;

FIG. 2 shows the electronic elements of a beam blanker connected to a scanning electron microscope;

FIG. 3 shows a SEM vacuum feed through/aperture holder/aperture device without a beam blanker;

FIG. 3A shows a top plan view of the right end of the device shown in FIG. 3;

FIG. 3B shows a side elevation view of the right end of the device shown in FIGS. 3 and 3A;

FIGS. 4A, 4B and 4C show an embodiment of a beam blanker with vacuum feed through;

FIG. 4A shows a side elevation view of the device shown in FIG. 4. and FIG. 4B shows a top view of the device shown in FIG. 4;

FIG. 4C shows a plan view of the right end of the device shown in FIG. 4;

FIGS. 5A, 5B and 5C show an embodiment of a vacuum feed through/aperture holder/aperture device, combined with a beam blanker;

FIG. 5A shows a top view of the device shown in FIG. 5;

FIG. 5B shows a side elevation view of the device shown in FIG. 5; and

FIG. 5C shows a cross-sectional view of the device shown in FIG. 5, which shows the placement of the blanker plates and aperture.

### DETAILED DESCRIPTION OF THE PREFERRED EMBODIMENT

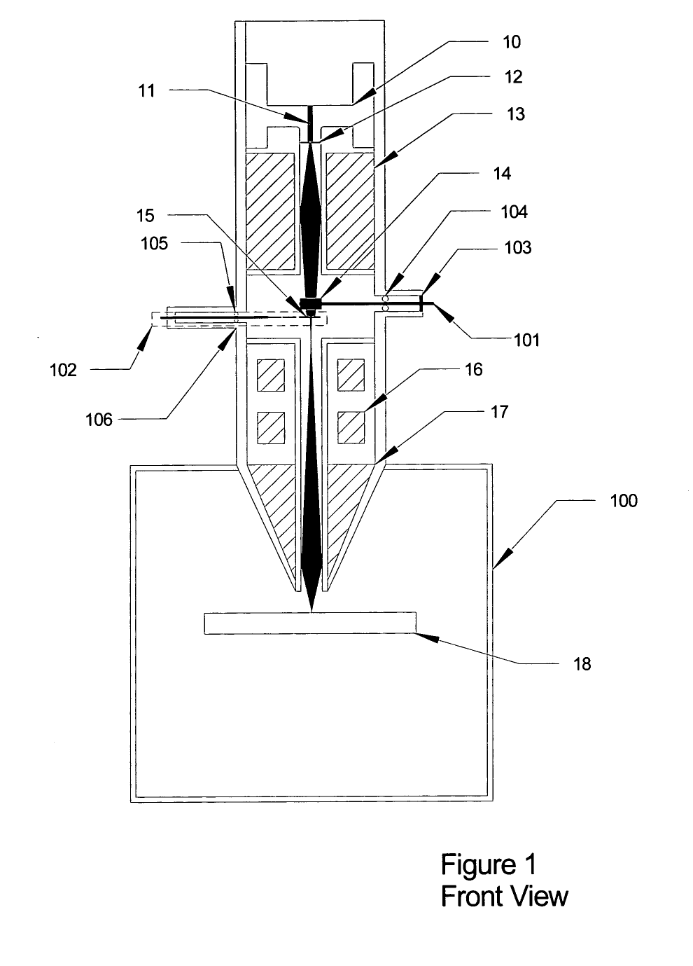

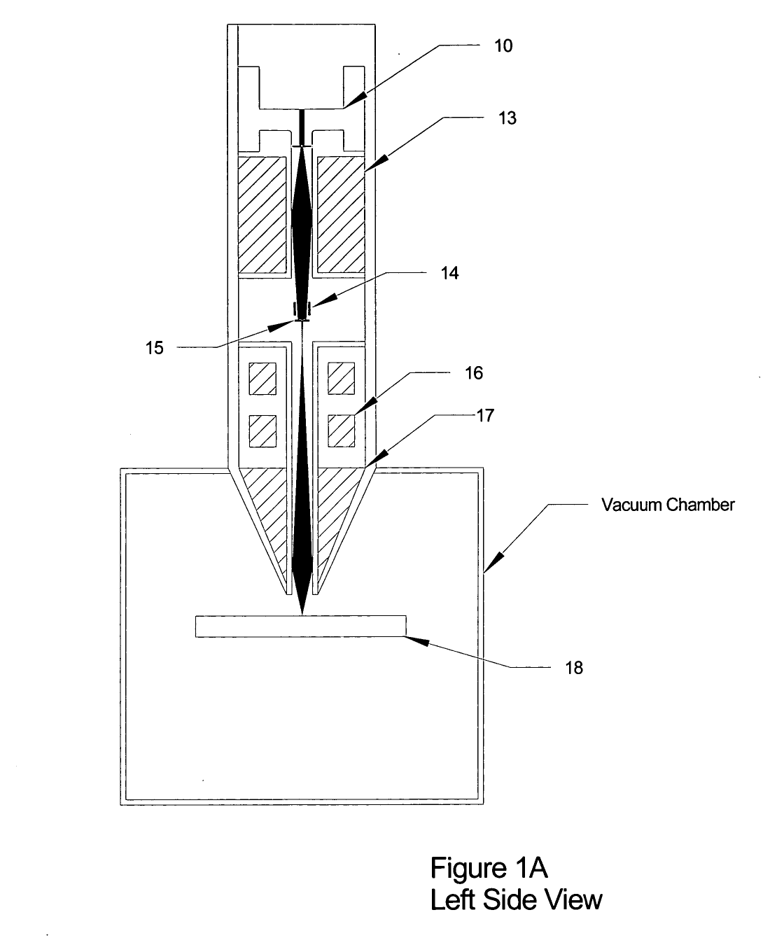

FIG. 1 shows schematically a charged particle source 10, e.g., a scanning electron microscope gun that generates a beam 11 on an axis. Beam 11 is directed past condenser aperture 12, condenser lens 13, beam blanker plates 14, objective aperture 15 and scan coils 16, through objective lens 17, and onto sample 18. When activated, beam blanker plates 14 divert the beam from its axis, and away from objective aperture 15, thus “blanking,” i.e., diverting the beam from the sample or target 18. A voltage, applied to one or both of beam blanker plates 14, attracts or repels the beam, depending upon voltage polarity, from the axis of the beam.

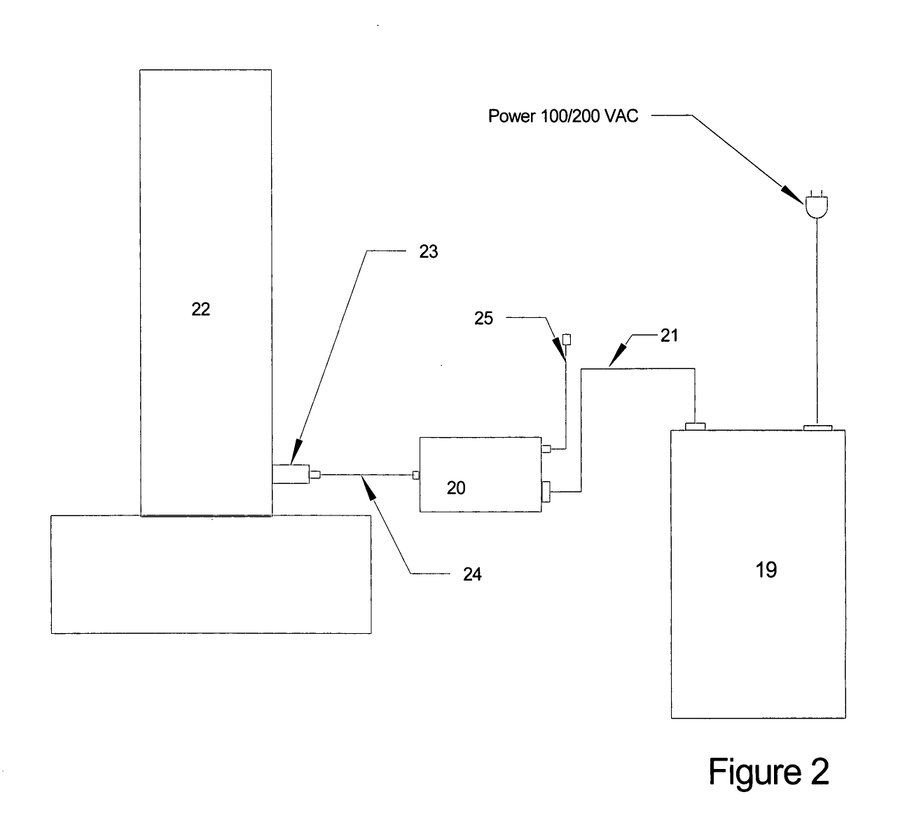

In some embodiments, as FIG. 2 shows, the blanker for SEM column 22 may include at least six elements: a power supply 19, connected to blanker driver 20 via cable 21, and vacuum feed through/blanker plates 23 connected to the blanker driver 20 via cable 24. The blanker driver 20 receives a signal from the computer via cable 25. In many embodiments of scanning electron microscopes, the electronics, namely the power supply and driver, are similar. The blanker plates and vacuum feed through, however, may vary, depending upon the structure and operation of the particular SEM. SEM column 22 includes an electron gun, aperture lens, and other elements; all are under vacuum during normal SEM operation. SEM column 22 also includes a final aperture adjustment mechanism. The size of this aperture can be externally modified to receive a combined vacuum feed through, beam blanker, aperture and aperture holder.

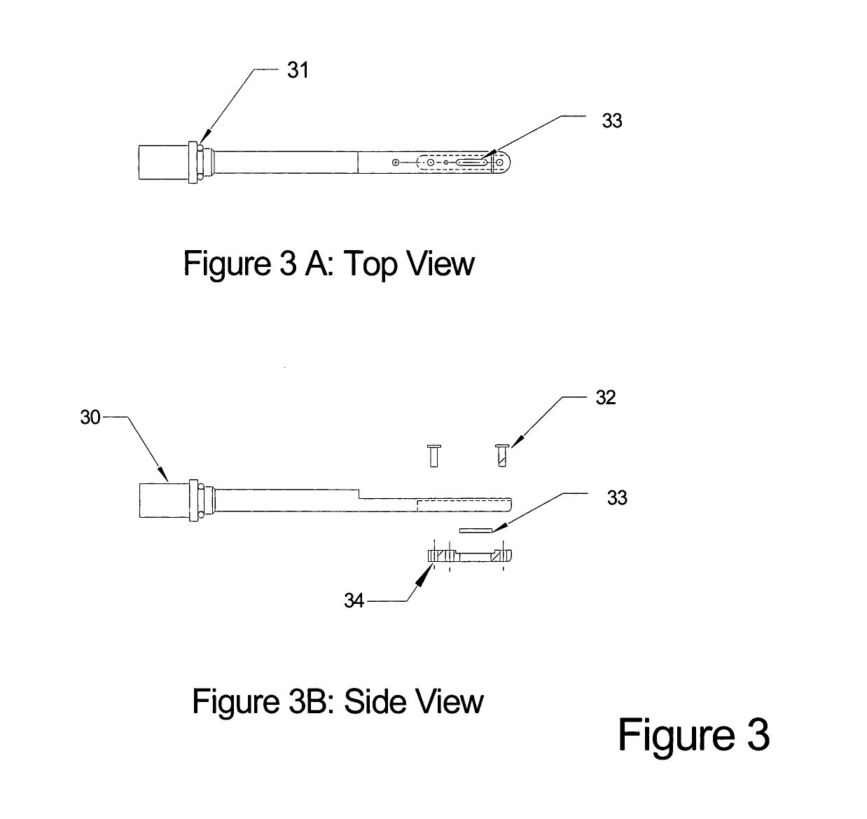

An existing SEM vacuum feed through/aperture holder/aperture device without a beam blanker is shown in FIGS. 3, 3A and 3B. The aperture holder may include aperture rod 30 with vacuum seal 31, aperture strip 33, aperture retainer 34 and retaining screws 32. Aperture strip 33 is secured to aperture rod 30 via aperture retainer 34. Aperture retainer 34 is secured to aperture rod 30 via retaining screws 32.

Aperture strip 33 has one or more holes that allow the beam to pass through. Where there are multiple holes, the beam is allowed to pass through each hole by positioning the aperture strip 33 at the axis of beam 11, using aperture rod 30.

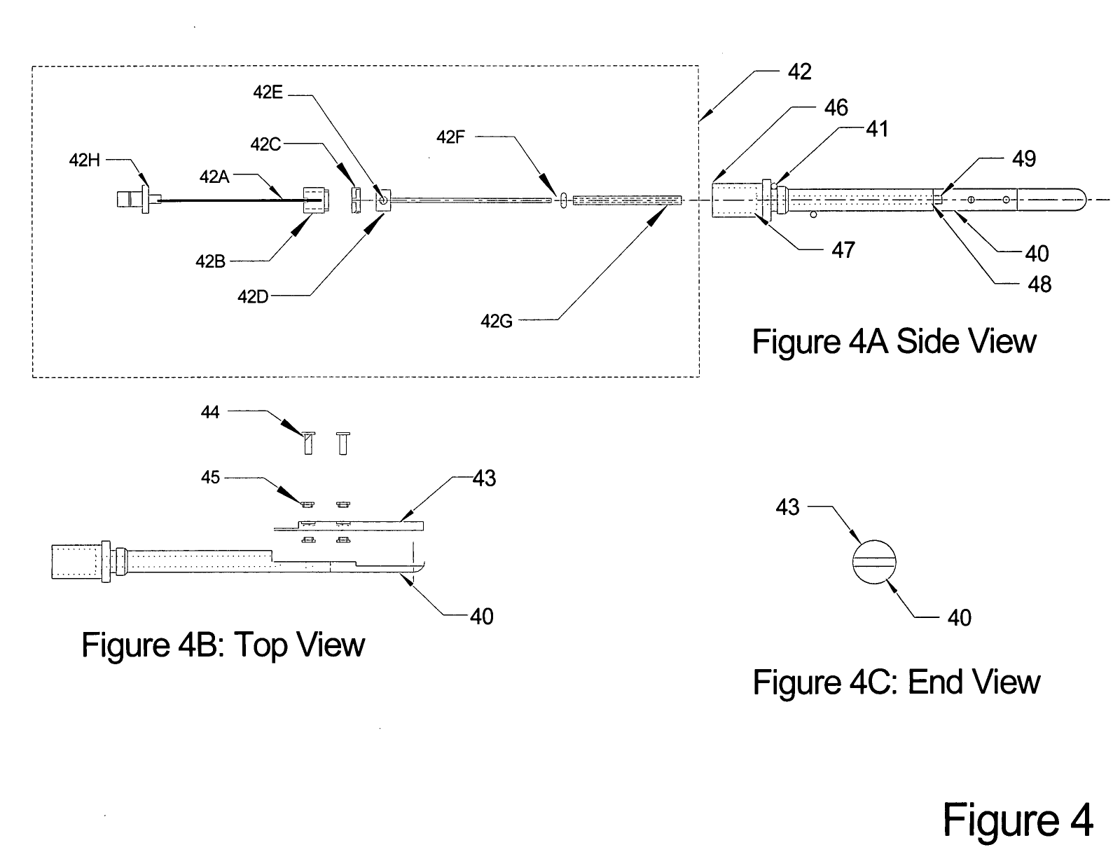

An existing SEM vacuum feed through beam blanker device is shown in FIGS. 4, 4A and 4B. This device may include ground plate 40 with vacuum seal 41, vacuum feed through 42, biased plate 43, insulators 45 and mounting screws 44. Vacuum feed through 42 may include insulated wire 42A, retaining screw 42B, insulating washer 42C, inner electrode 42D, vacuum seal 42F, and insulator tube 42G. Insulated wire 42A has the insulation removed at the ends, exposing the inner conductor which is secured to inner electrode 42D via setscrew 42E at one end and soldered to connector 42H at the opposite end. Ground plate 40 has a longitudinally extending passage from opening 46 at one end to opening 49 near the center of the rod. Insulator tube 42G extends from opening 47 to opening 48 and is inserted into ground plate 40. Inner electrode 42D is inserted through vacuum seal 42F, then inserted into insulator 42G in ground plate 40. Insulating washer 42C is placed over inner electrode 42D, and has an opening extending through the washer to allow passage of insulating wire 42A. Retaining screw 42B has an opening extending longitudinally through the screw to allow passage of insulating wire 42A. Retaining screw 42B is placed over insulating washer 42C, and is secured to ground plate 40. Insulated wire 42H is connected to cable 24 shown in FIG. 2. Connector 42H may be electrically connected between cable 24 in FIG. 2 and insulated wire 42A to facilitate assembly.

Properly assembled, vacuum feed through 42 provides electrical connection from connector 42H to biased plate 43 through insulated wire 42A and inner electrode 42D. Inner electrode 42D is prevented from shorting to ground plate 40 via insulating washer 42C, vacuum seal 42F, and insulator tube 42G. Inner electrode 42D extends beyond opening 48, but does not extend as far as opening 49, and is in contact with biased plate 43. Thus, electrical connection is achieved to allow the biased plate 43 to deflect the beam 11 when a voltage is applied externally.

Biased plate 43 is attached to ground plate 40 through insulators 45 via mounting screws 44. Biased plate 43 is in electrical contact with inner electrode 42D via the opening 48 through opening 49.

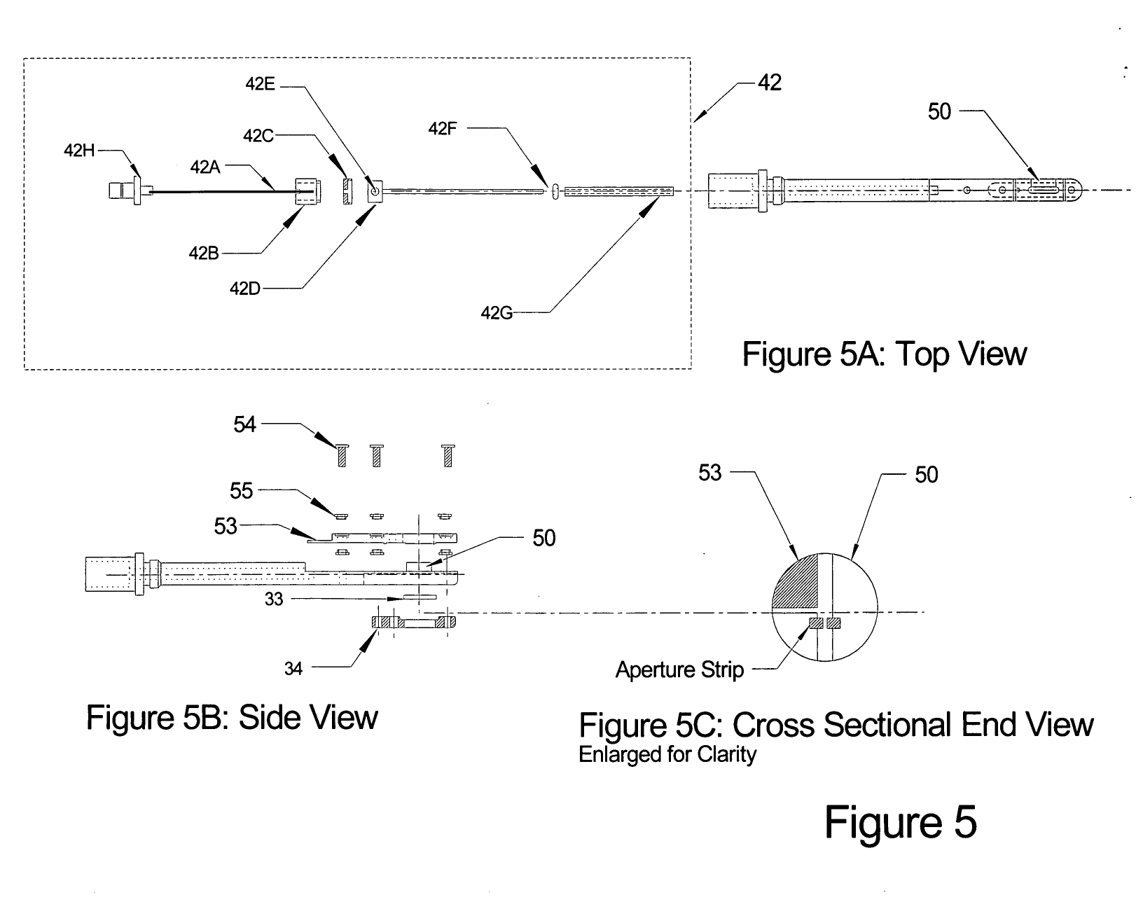

FIGS. 5, 5A, 5B and 5C show the aperture holder/aperture device of FIG. 3, combined with a vacuum feed through/beam blanker shown in FIG. 4. In FIG. 5A, vacuum feed through 42 is identical in description and function to the vacuum feed through 42 in FIG. 4A. In FIG. 5A, aperture strip 33 and aperture retainer 34 are as shown in FIG. 3B, and serve the same function. FIG. 5C shows that the opposing plates may be placed above or below the aperture within the device, as space permits, and are here above the aperture.

In use, when an electrical signal is applied to connector 42H, the signal activates plate 43, diverting the electron beam away from aperture 33 and, thus blanking the beam.

The integrated beam blanker need not be limited to the aperture assembly described here but may be incorporated in a number of devices that have existing vacuum ports; e.g., vacuum manifolds, detectors, and electrical feed throughs.

1. A combined aperture holder, vacuum feed through and beam blanker for a beam of charged particles, comprises a tube or rod that has a size and shape adapted to fit into an existing aperture in a scanning electron microscope or an ion beam chamber, said tube or rod including a longitudinally-extending internal passage, a first open end, a second open end, a first connector that fits with, and seals said tube or rod at said first open end; an electrically conductive member, connected to said first connector at one end, and of sufficient length to pass through said internal passage and extend beyond the second end of said first tube or rod; a second connector that fits with the second open end of said tube or rod, said second connector including a longitudinally-extending internal passage through which said electrically conductive member passes; at the end of said second connector, a ground plate for said blanker, formed in said second connector; and, connected to and insulated from said ground plate, a conductive plate for said beam blanker, said second end including an aperture holder and aperture for said beam.

2. A combined aperture holder, vacuum feed through and beam blanker for a beam of charged particles, comprises a tube or rod that has a size and shape adapted to fit into an existing aperture in a scanning electron microscope or an ion beam chamber, a first end, a second end, a first connector that fits with said tube or rod at said first open end; an electrically conductive member, connected to said first connector at one end, and of sufficient length to extend beyond the second end of said first tube or rod; a second connector that fits with the second end of said tube or rod, said second connector including a passage through which said electrically conductive member passes; at the end of said second connector, a ground plate for said blanker, formed in said second connector; and, connected to and insulated from said ground plate, a conductive plate for said beam blanker, said second end including an aperture holder and aperture for said beam.
